(19) United States
(12) Patent Application Publication
(10) Pub. No.: US 2007/0045192 A1
(43) Pub. Date: Mar. 1, 2007

(54) Biocide management arrangement

(75) Inventors: Timothy A. Nalette, West Stafford, CT (US); John W. Steele, New Hartford, CT (US)

Correspondence Address: CARLSON, GASKEY & OLDS, P.C., 400 WEST MAPLE ROAD, SUITE 350, BIRMINGHAM, MI, 48009, US

(73) Assignee: Hamilton Sundstrand

(21) Appl. No.: 11/215,109

(22) Filed: Aug. 30, 2005

(51) Int. Cl. C02F 1/50

(52) U.S. Cl. 210/662; 210/764; 210/205

(57) ABSTRACT

A chemical concentration control arrangement includes two sorbent beds that cooperate to control a chemical concentration in a fluid. One of the sorbent beds selectively removes the chemical to reduce the concentration and the other sorbent bed selectively releases the chemical to increase the concentration. In a cooling system, the sorbent beds are used to control a biocide concentration in circulating coolant.

### BACKGROUND OF THE INVENTION

This invention relates to chemical concentration control and, more particularly, to an arrangement for controlling the chemical concentration of a biocide in a coolant circulating in a cooling system.

Conventional cooling systems, such as that used in a space station, contain an aqueous-based coolant to cool the space station operating systems. Conventionally, the cooling systems include a biocide to reduce or prevent growth of microorganisms. Particular biocides, such as silver-salt, undesirably precipitate out of the coolant and become ineffective as a biocide. Furthermore, silver precipitation may lead to galvanic corrosion with metals and coatings of parts within the system. Alternative biocides may be less likely to precipitate out, but several key challenges remain before implementation.

One challenge is introducing the biocide into the cooling system under microgravity conditions without allowing the biocide to escape into the surrounding cabin. Another challenge includes designing a handling system that is capable of controlling the biocide concentration in the coolant by selectively removing or delivering biocide. Finally, the handling system should be relatively simple and inexpensive.

Accordingly, there is a need for a simple arrangement to introduce and remove biocide from a coolant system with minimal risk of cabin exposure.

### SUMMARY OF THE INVENTION

The control arrangement according to the present invention includes two sorbent beds that cooperate to control a chemical concentration in a fluid. One of the sorbent beds selectively removes the chemical if the concentration is too high and the other sorbent bed selectively releases the chemical if the concentration is too low.

In one example, the sorbent beds are connected in a cooling system to control a biocide concentration in coolant circulating through the cooling system. A controller selectively opens and closes valves to control coolant flow through the sorbent beds. The controller changes the biocide concentration by a predetermined amount by controlling the fluid flow rate and flow time through the sorbent beds.

Accordingly, the control arrangement according to the present invention provides a simple arrangement for automatically introducing or removing biocide in a cooling system and reduces the need to manually handle the biocide.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows.

FIG. 1 is a schematic view of an example cooling system.

FIG. 2 is a schematic view of an example control assembly having two sorbent beds.

FIG. 3 shows example data for samples of a sorbent bed for delivering biocide.

FIG. 4 shows example data for samples of a sorbent bed for removing biocide.

### DETAILED DESCRIPTION OF THE PREFERRED EMBODIMENT

FIG. 1 illustrates a schematic view of selected portions of an exemplary thermal control system 10 that includes a unit 12 that produces heat during operation. An aqueous-based coolant, for example, circulates through conduits 14 between a heat exchanger 16 and the unit 12 to remove the heat from the unit 12 and to maintain a preferred operating temperature. The aqueous-based coolant includes a biocide agent, such as an aldehyde, glutaraldehyde, or ortho-phthalaldehyde, for example, to destroy biological organisms.

A control assembly 18 connected to the conduit 14 maintains a desirable biocide concentration in the circulating coolant. The control assembly 18 removes biocide if the concentration becomes higher than desired and introduces biocide if the concentration becomes lower than desired. The control assembly 18 provides the benefit of maintaining the biocide concentration within a desired range without having to manually introduce or remove the biocide using external connections or complex pumps.

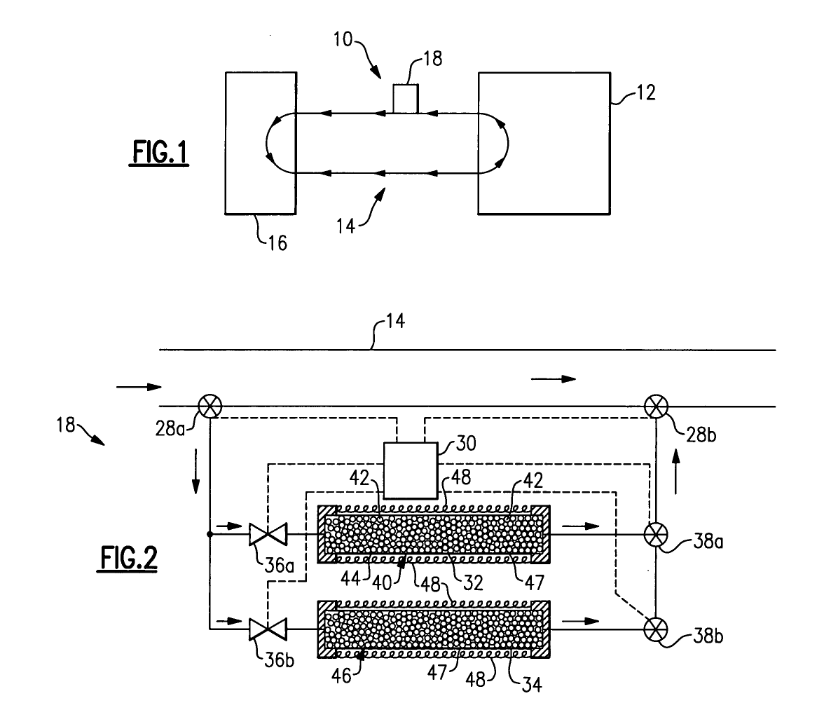

FIG. 2 illustrates a schematic view of an example control assembly 18. A pair of fluid valves 28a and 28b control fluid flow, respectively, from the conduit 14 into the control assembly 18 and from the control assembly back into the conduit 14. A controller 30 commands the fluid valves 28a and 28b to open or close, depending on whether or not the biocide concentration in the coolant requires adjustment. The biocide concentration can be determined manually or automatically using known methods.

If the biocide concentration is too high or too low, the controller 30 opens the valve 28a to divert coolant flow into the control assembly 18. Sorbent beds 32 and 34 adjust the biocide concentration. If the concentration is lower than desired, the sorbent bed 32 introduces biocide into the coolant to increase the concentration. If the concentration is greater than desired, the sorbent bed 34 removes biocide to lower the concentration.

The controller 30 controls metering valves 36a and 36b to selectively divert coolant flow into either of the sorbent beds 32 or 34. The controller 30 utilizes the metering valves 36a and 36b to control the coolant volume flowing into either sorbent bed 32 or 34. This allows control of the biocide concentration by varying the fluid flow rate and flow time through either of the sorbent beds 32 or 34. The rate at which the sorbent beds 32 and 34 respectively introduce and remove biocide can be determined empirically such that the controller 30 changes the biocide concentration a predetermined amount by controlling the fluid flow rate and flow time through either of the sorbent beds 32 or 34. The resulting adjusted concentration of the coolant can be determined manually or automatically using known methods.

Check valves 38a and 38b near the outlets of the sorbent beds 32 and 34 prevent backflow of coolant. When coolant flows through one of the sorbent beds 32 or 34, the controller 30 opens the corresponding check valve 38a or 38b to allow the coolant to flow back into the conduit 14 through the valve 28b. The controller closes the other check valve 38a or 38b to prevent backflow into the inactive sorbent bed 32 or 34.

In the illustrated example, the sorbent bed 32 includes a porous material 40, such as a carbon material, alumina, acrylic ester, or polymethylmethacrylate. Optionally, the porous material 40 may be granulized in a known manner to form granules 42. The porous material 40 is structurally robust to withstand coolant flow without cracking. Biocide is impregnated into pores of the porous material 40 by soaking the porous material 40 in a solution of solvent and biocide and subsequently evaporating out the solvent to leave the biocide immobilized within the porous material 40. The biocide diffuses from the pores of the porous material 40 into coolant passing between the granules 42 to increase the biocide concentration in the coolant. In one example, a biocide concentration gradient between the pores of the porous material 40 and the coolant provides a driving force for diffusion of the biocide into the coolant.

In the illustrated example, the sorbent bed 34 includes an adsorbent material 46, such as activated carbon. The activated carbon material is granulized in a known manner and held in a support 47 such as a canister or netting. In other examples, a zeolite, clay, activated alumina, silica or combination thereof is used. Other known adsorbents may also be used. The adsorbent material 46 removes biocide from the passing coolant to reduce the biocide concentration. As is known, adsorbent materials include surfaces that bind other substances. The carbon of the adsorbent material 46 binds biocide to remove it from the coolant. Given this description, those of ordinary skill in the art will recognize that other types of sorbent beds 32 and 34 may be used in other fluid systems, such as but not limited to controlling concentrations of other types of chemicals or biocides in aqueous or non-aqueous fluids.

Each of the sorbent beds 32 and 34 includes spring members 48. The spring members 48 compress and compact the sorbent beds 32 and 34. During operation of the control assembly 18, for example, sorbent bed 32 shrinks as it is depleted of biocide. If the sorbent bed 32 is not compacted, there is risk of excess space within the sorbent bed 32 that may allow the coolant to bypass the sorbent bed 32 without delivery of biocide. Thus, the spring members 48 compact the porous material 40 to minimize the excess space produced by shrinkage.

Under microgravity conditions and the pressure of the flowing coolant, the granules of sorbent bed 34 may move. The spring member 48 prevents significant movement of the granules and maintains a relatively tight packing of granules.

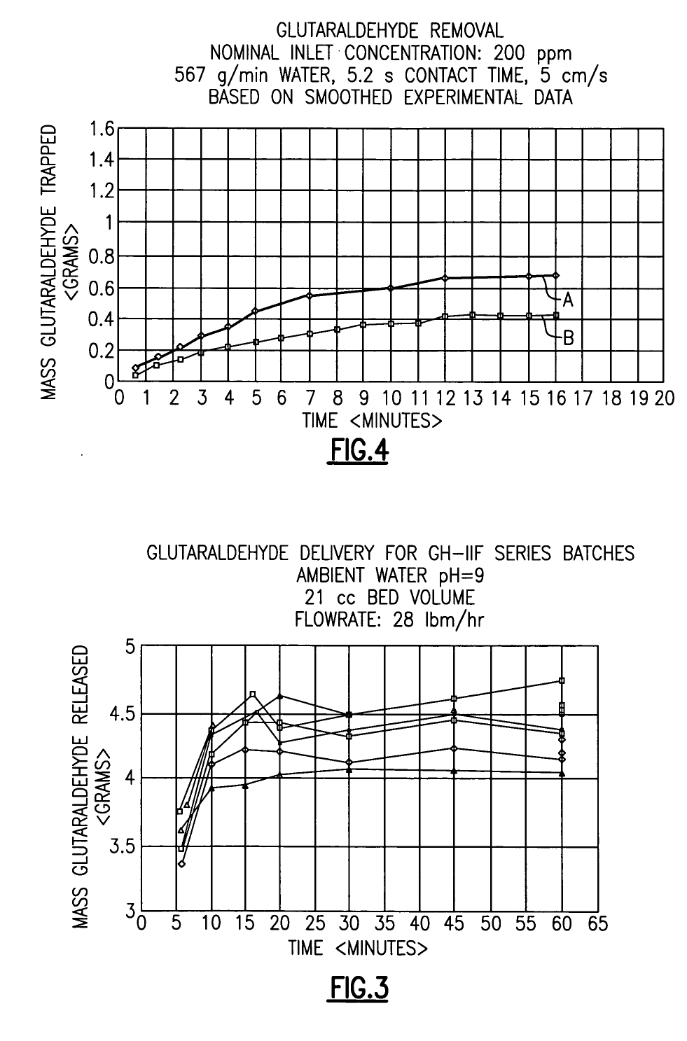

FIGS. 3 and 4 illustrate experimental examples of biocide removal and delivery. These experimental examples are shown to illustrate one example of removal and delivery of a biocide and are not meant to be limiting in any way. FIG. 3 shows data for numerous samples of a sorbent bed 32 for delivering glutaraldehyde. The illustrated experimental example utilized ambient water having a pH of 9, a 21 cm³ sorbent bed 32 volume, and a flow rate of 28 lbm/hr.

FIG. 4 shows data for two samples, A and B, of a carbon sorbent bed 34 for removing glutaraldehyde. The illustrated experimental example utilized a coolant water mass flow of 567 g/min with an initial glutaraldehyde concentration of 200 ppm.

Although a preferred embodiment of this invention has been disclosed, a worker of ordinary skill in this art would recognize that certain modifications would come within the scope of this invention. For that reason, the following claims should be studied to determine the true scope and content of this invention.

We claim:

1. A chemical concentration control arrangement comprising:
first and second sorbent beds selectively receiving a fluid and cooperating to remove a selected chemical or release said selected chemical to control a desired chemical concentration of said chemical in the fluid.

2. The arrangement as recited in claim 1, wherein said first sorbent bed selectively releases said selected chemical into the fluid and said second sorbent bed selectively removes said selected chemical from said fluid.

3. The arrangement as recited in claim 2, wherein said first sorbent bed includes a porous material having absorbed chemical therein.

4. The arrangement as recited in claim 3, wherein said first sorbent bed comprises at least one of a carbon material, alumina, acrylic ester, polymethylmethacrylate, or mixtures thereof.

5. The arrangement as recited in claim 3, wherein said first sorbent bed includes an absorbed biocide.

6. The arrangement as recited in claim 3, wherein said biocide comprises at least one of an aldehyde, glutaraldehyde, or ortho-phthalaldehyde.

7. The arrangement as recited in claim 2, wherein said second sorbent bed includes a chemical adsorbing material.

8. The arrangement as recited in claim 7, wherein said chemical adsorbing material comprises at least one of an activated carbon zeolite, activated alumina, clay, silica, or mixture thereof.

9. The arrangement as recited in claim 2, further comprising a controller in communication with inlet metering valves, said controller controlling said inlet metering valves to selectively control fluid flow into said first and second sorbent beds.

10. The arrangement as recited in claim 1, wherein at least one of said sorbent beds includes a bias member compressing said at least one of said sorbent bed.

11. A chemical concentration control arrangement comprising:
a fluid for conduit carrying a fluid;
first and second sorbent beds that selectively receive the fluid from the fluid conduit and either remove a selected chemical from the fluid or release said selected chemical into the fluid; and
a controller selectively controlling fluid flow into said sorbent beds to control a chemical concentration in the fluid.

12. The arrangement as recited in claim 11, wherein said first and second sorbent beds each include an inlet metering valve.

13. The arrangement as recited in claim 12, wherein said first and second sorbent beds each include an outlet check valve.

14. The arrangement as recited in 13, further comprising a first fluid valve between said inlet metering valve and said fluid conduit and a second fluid valve between said outlet check valve and said fluid conduit.

15. The arrangement as recited in claim 11, wherein said fluid conduit is fluidly connected to a heat exchanger.

16. A method for controlling a chemical concentration in a fluid, comprising:
(a) selectively controlling flow of a fluid having a chemical concentration into first and second sorbent beds;
(b) removing a selected chemical if the chemical concentration is higher than desired; and
(c) releasing the selected chemical if the chemical concentration is lower than desired to maintain the chemical concentration in a selected range.

17. The method as recited in claim 16, wherein said step (b) includes controlling the fluid flow through the first sorbent bed to selectively remove the selected chemical.

18. The method as recited in claim 17, wherein said step (c) includes controlling the fluid flow through the second sorbent bed to selectively release the selected chemical.

19. The method as recited in claim 18, wherein said step (a) includes controlling a flow rate through a metering valve into the first or second sorbent bed.

20. The method as recited in claim 19, wherein said step (a) includes selectively allowing fluid flow into the first sorbent bed and preventing flow into the second sorbent bed if the chemical concentration is greater than a desired concentration and selectively allowing fluid flow into the second sorbent bed and preventing flow into the first sorbent bed if the chemical concentration is less than a desired concentration.
